(19) United States
(12) Patent Application Publication
(10) Pub. No.: US 2020/0294688 A1
(43) Pub. Date: Sep. 17, 2020

(54) Double-Sided Metal Mesh Conductive Particle and Pushbutton Having the Same

(71) Applicants: Yanfen Qi, Dongguan (CN); Shengding Electronics Co., Ltd., Dongguan (CN)

(72) Inventors: Yanfen Qi, Dongguan (CN); Yuanping Qi, Dongguan (CN); Yuanan Qi, Dongguan (CN)

(73) Assignees: Yanfen Qi; Shengding Electronics Co., Ltd.

(21) Appl. No.: 16/809,324

(22) Filed: Mar. 4, 2020

(30) Foreign Application Priority Data
Mar. 15, 2019 (CN) 201920338496.1

(51) Int. Cl. H01B 5/14; H01H 1/021

(52) U.S. Cl. CPC H01B 5/14; H01H 13/02; H01H 1/021

(57) ABSTRACT

A double-sided metal mesh conductive particle and a pushbutton having the double-sided metal mesh conductive particle. The double-sided metal mesh conductive particle includes a first metal mesh layer, a first adhesive layer, a base layer, a second adhesive layer, and a second metal mesh layer arranged sequentially from top to bottom; an upper surface of the first metal mesh layer has a multiple of first conductive bumps, and a lower surface of the second metal mesh layer has a multiple of second conductive bumps. The double-sided metal mesh conductive particle ensures a reliable contact with a circuit and provides a good electrical conductivity and a double-sided conduction. When the conductive particle is installed to a pushbutton with an electrical contact function, a double-sided conduction can be achieved to prevent the conductive particle from being installed in a wrong direction or affecting the electrical conductivity.

### BACKGROUND OF INVENTION

### Field of Invention

The present invention relates to the technical field of conductive particles, in particular to a double-sided metal mesh conductive particle and a pushbutton having the double-sided metal mesh conductive particle.

### Description of the Related Art

With the development of society and the advancement of science and technology, pushbuttons with an electrical contact function have been used widely in industrial production and people's daily life. At present, the pushbutton with electric contact function used in motor vehicles, mobile phones, computers, medical equipment, and other products requires a conductive particle used as a conductive component. The conductive particle generally includes a base glue layer and a metal contact surface connected to the base glue layer.

However, the conventional conductive particle usually has the following drawbacks: 1. The conventional conductive particle is usually formed by carbon powder, nickel powder or foam nickel sheet and silicone and features a low cost but a high coefficient of resistance of the conductivity. To improve the conductivity, manufacturers have to decrease the proportion of silicone and increase the proportion of conductive materials. After a long term of being contacted or rub, it is easy for the powder of the conductive particle to fall off, and the fallen carbon may burn the printed circuit board (PCB) easily, so that the service life is short. 2. During the production process, adhesives may be overflown, so that the non-conductive base glue layer is higher than the metal contact surface or metal contact surface trapped into the base glue layer, and non-conductive foreign substances is formed between the pushbutton and the PCB. As a result, the conductive function is poor. 3. To improve the aforementioned drawbacks, flat gold particles or gold plated conductive particles are introduced, but the cost is high. In addition, only one side has the metal contact surface, so that a double-sided conduction cannot be achieved. When the conductive particle is installed to the pushbutton with the electrical contact function, both sides of the pushbutton have to be identified manually, so that the production efficiency is low and the production cost is high. Furthermore, the conductive particle may be installed reversely, and thus affecting the product yield and reliability. 4. A flat metal conductive particle has a smooth metal contact surface without any convex and cave structures, so that the point contact with a circuit cannot be achieved. When there is dust or dirt on the contact surface, a poor contact may cause the circuit to be non-conductive.

### SUMMARY OF THE INVENTION

In view of the aforementioned drawbacks of the prior art, it is a primary objective of the invention to provide a double-sided metal mesh conductive particle that guarantees a reliable contact with the circuit and a good electrical conductivity and has the function of double-sided conduction. When the conductive particle is installed to a pushbutton with an electrical contact function, a double-sided conduction is achieved to prevent the conductive particle from being installed in a wrong side or affecting the electrical conductivity, so as to improve the assembling efficiency and the product yield of the pushbutton significantly and provide the features of low production cost, long service life, and good usability.

To achieve the aforementioned and other objectives, the present invention provides a double-sided metal mesh conductive particle, comprising: a first metal mesh layer, a first adhesive layer, a base layer, a second adhesive layer, and a second metal mesh layer arranged sequentially from top to bottom; and an upper surface of the first metal mesh layer having a plurality of first conductive bumps, and a lower surface of the second metal mesh layer having a plurality of second conductive bumps.

Further, the base layer is a silicone layer.

Further, the plurality of first conductive bumps is uniformly distributed on an upper surface of the first metal mesh layer; and the plurality of second conductive bumps is uniformly distributed on a lower surface of the second metal mesh layer.

Further, the lower surface of the first metal mesh layer and the upper surface of the first adhesive layer are adhered with each other, and the plurality of first conductive bumps is protruded from the first adhesive layer.

Further, the height of the plurality of first conductive bumps protruded from the first adhesive layer is not less than half of the thickness of the first metal mesh layer.

Further, an upper surface of the second metal mesh layer and a lower surface of the second adhesive layer are adhered with each other, and the plurality of second conductive bumps is protruded from the second adhesive layer.

Further, the height of the plurality of second conductive bumps protruded from the second adhesive layer is not less than half of the thickness of the second metal mesh layer.

Further, the first metal mesh layer and the second metal mesh layer are iron mesh layers, copper mesh layers, nickel mesh layers, stainless steel mesh layers, titanium mesh layers, gold mesh layers, sliver mesh layers, gold plated mesh layers, silver plated mesh layers, copper plated mesh layers, nickel plated mesh layers, titanium plated mesh layers or chromium plated mesh layers.

Further, the first adhesive layer and the second adhesive layer are adhesive layers made of the same material.

This invention further provides a pushbutton having the aforementioned double-sided metal mesh conductive particle.

The present invention has the following advantages effects: With the first metal mesh layer, the first adhesive layer, the base layer, the second adhesive layer and the second metal mesh layer of this invention, both upper and lower surfaces of the conductive particle can be used as a conductive contact surface, and the first metal mesh layer and the second metal mesh layer have conductive bumps to ensure a reliable contact between the conductive particle and the circuit and provide good electrical conductivity, high softness, and low contact resistance. Since the double-sided metal mesh conductive particle has the double-sided conduction function, therefore when the conductive particle is installed to a pushbutton with an electrical contact function, it is not necessary to identify both surfaces manually in order to prevent the conductive particle from being installed reversely or affecting the electrical conductivity of the pushbutton, so as to improve the assembling efficiency and the product yield of the pushbutton significantly, and the invention has the features of low production cost, long service life, and good usability.

### BRIEF DESCRIPTION OF THE DRAWINGS

FIG. 1 is a cross-sectional view of a double-sided metal mesh conductive particle of the present invention;

FIG. 2 is a top view of a double-sided metal mesh conductive particle of the present invention; and

FIG. 3 is a schematic view showing the structure of a pushbutton installed with the double-sided metal mesh conductive particle in accordance with the present invention.

Brief Description of Numerals Used in the Drawings: 1: First metal mesh layer; 11: First conductive bump; 12: lower convex connecting portion; 2: First adhesive layer; 3: Base layer; 4: Second adhesive layer; 5: Second metal mesh layer; 51: Second conductive bump; 52: Upper convex connecting portion; 6: Double-sided metal mesh conductive particle; 7: Pushbutton; 71: Pushbutton head; 72: Pushbutton elastic wall; 73:Chamber; and 8: PCB.

### DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

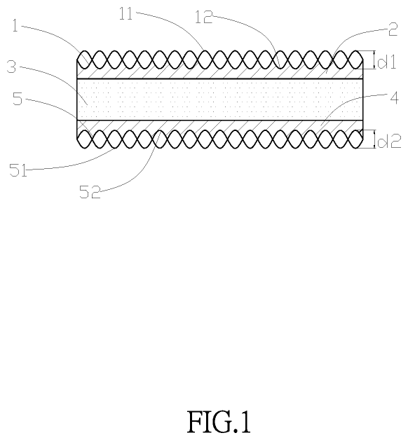

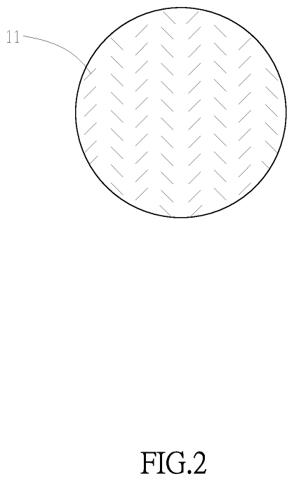

With reference to FIGS. 1 to 3 for a double-sided metal mesh conductive particle 6 of the present invention, the double-sided metal mesh conductive particle 6 comprises a first metal mesh layer 1, a first adhesive layer 2, a base layer 3, a second adhesive layer 4, and a second metal mesh layer 5 arranged sequentially from top to bottom, wherein an upper surface of the first metal mesh layer 1 has a plurality of first conductive bumps 11, and a lower surface of the second metal mesh layer 5 has a plurality of second conductive bumps 51.

With the first metal mesh layer 1, the first adhesive layer 2, the base layer 3, the second adhesive layer 4 and the second metal mesh layer 5 arranged sequentially from top to bottom, both upper and lower surfaces of the conductive particle can be conductive, and both surfaces can be used as a conduct contact surface. In addition, the first metal mesh layer 1 and the second metal mesh layer 5 have conductive bumps to guarantee the conductive particle to have a reliable contact with the circuit and achieve a good electrical conductivity. When the conductive particle is installed to a pushbutton 7 with the an electrical contact function, it is not necessary to identify both surfaces manually in order to prevent the conductive particle from being installed reversely or affecting the electrical conductivity of the pushbutton 7, so as to improve the assembling efficiency and the product yield of the pushbutton 7 significantly, and the invention has the features of low production cost, long service life, and good usability.

Further, the base layer 3 is a silicone layer. The silicone layer has good thermal stability, weather resistance, and electrical insulation and it has the effect of resisting high/low temperature and provides high chemical stability and mechanical strength to improve the reliability and service life of the double-sided metal mesh conductive particle 6.

Further, the plurality of first conductive bumps 11 is uniformly distributed on an upper surface of the first metal mesh layer 1; and the plurality of second conductive bumps 51 is uniformly distributed on a lower surface of the second metal mesh layer 5. In this embodiment, the metal conductive mesh is used to substitute the traditional method of mixing a metal powder, so that the electrical conductivity and the service life of the conductive particle can be improved. The first metal mesh layer 1 and the second metal mesh layer 5 has a first conductive bump 11 and a second conductive bump 51 respectively to ensure that a good point contact and a dense and uniform distribution between the double-sided metal mesh conductive particle 6 and the circuit, so that the circuit can be conducted easily. To overcome the drawbacks of the conventional metal contact surface having dust and dirt that may cause a poor contact between the conductive particle and the PCB 8 easily. In addition, the first metal mesh layer 1 and the second metal mesh layer 5 form convex and concave structures, the adhesive layer has an increased adhesive strength, so that the first metal mesh layer 1 and the second metal mesh layer can be combined with the base layer 3 securely to extend the service life of the conductive particle.

Further, a lower surface of the first metal mesh layer 1 and an upper surface of the first adhesive layer 2 are adhered with each other, and the plurality of first conductive bumps 11 is protruded from the first adhesive layer 2. The first metal mesh layer 1 and the first adhesive layer 2 can be combined securely, and the first metal mesh layer 1 has a good point contact with the circuit. Further, the first metal mesh layer 1 is formed by weaving a plurality of metal filaments, and the first conductive bump 11 is formed by extending the metal filaments upwardly from the upper surface of the first metal mesh layer 1. A lower convex connecting portion 12 is formed by extending the metal filaments downwardly from the lower surface of the first metal mesh layer 1, and the lower convex connecting portion 12 is coupled to the first adhesive layer 2.

Further, the height of the plurality of first conductive bumps 11 protruded from the first adhesive layer 2 is not less than half of the thickness of the first metal mesh layer 1. Both upper and lower surfaces of the first metal mesh layer 1 are rough, but not flat. When the first metal mesh layer 1 is adhered with the first adhesive layer 2, the lower convex connecting portion 12 is extended into the first adhesive layer 2; and the first adhesive layer 2 is protruded from the first conductive bump 11 of the upper surface can prevent the first adhesive layer 2 from going beyond the first conductive bump 11 or the upper surface of the first metal mesh layer 1, and a non-conductive foreign substance is formed between the pushbutton 7 and the PCB 8, and thus affecting the conductivity of the conductive particle. In this embodiment, the thickness of the first metal mesh layer 1 refer to the distance d1 from the upper end of the first conductive bump 11 to the lower end of the lower convex connecting portion 12 as shown in FIG. 1.

Further, an upper surface of the second metal mesh layer 5 and a lower surface of the second adhesive layer 4 are adhered with each other, and the plurality of second conductive bumps 51 is protruded from the second adhesive layer 4. The second metal mesh layer 5 and the second adhesive layer 4 are combined securely, and the second metal mesh layer 5 has a good point contact with the circuit. Further, the second metal mesh layer 5 is formed by weaving a plurality of metal filaments, and the second conductive bump 51 is formed by extending the metal filament downwardly from the lower surface of the second metal mesh layer 5. An upper convex connecting portion 52 is formed by extending the metal filament upwardly from the upper surface of the second metal mesh layer 5, and the upper convex connecting portion 52 is coupled to the second adhesive layer 4.

Further, the height of the plurality of second conductive bumps 51 protruded from the second adhesive layer 4 is not less than half of the thickness of the second metal mesh layer 5. Both upper and lower surfaces of the second metal mesh layer 5 are rough but not flat. When the second metal mesh layer 5 and the second adhesive layer 4 are adhered with each other, the upper convex connecting portion 52 is extended into the second adhesive layer 4; and the second conductive bump 51 formed on the upper surface of the second metal mesh layer 5 and protruded from the second adhesive layer 4 can prevent the second adhesive layer 4 from going beyond the second conductive bump 51 or passing through the lower surface of the second metal mesh layer 5, and a non-conductive foreign substance is formed between the pushbutton 7 and the PCB 8, and thus affecting the conductivity of the conductive particle. In this embodiment, the thickness of the second metal mesh layer 5 refers to the distance d2 from the lower end of the second conductive bump 51 to the upper end of the upper convex connecting portion 52 as shown in FIG. 1.

Further, the first metal mesh layer 1 and the second metal mesh layer 5 are iron mesh layers, copper mesh layers, nickel mesh layers, stainless steel mesh layers, titanium mesh layers, gold mesh layers, sliver mesh layers, gold plated mesh layers, silver plated mesh layers, copper plated mesh layers, nickel plated mesh layers, titanium plated mesh layers or chromium plated mesh layers. The first metal mesh layer 1 and the second metal mesh layer 5 are made of the aforementioned materials, so that a dense conductive network is formed on the surface of the conductive particle, and this invention has the advantages of good electrical conductivity, high productivity, low cost, and long service life.

Further, the first adhesive layer 2 and the second adhesive layer 4 are adhesive layers made of the same material. The adhesive layer is made of an adhesive and capable of adhering the first metal mesh layer 1 and the second metal mesh layer with the silicone layer.

The preparation method of this invention comprises the steps of: coating a semi-solid adhesive on a surface of the first metal mesh layer 1 and a surface of the second metal mesh layer to form a first adhesive layer 2 and a second adhesive layer 4 respectively; setting the silicone layer onto the first adhesive layer 2 and the second adhesive layer 4, and then putting them into a mold for a hot-pressing formation, and stamping the product into different sizes according to different specifications. This invention overcomes the following drawbacks of the prior art, wherein the adhesive may be overflown easily during the direct lamination process while the metal mesh and the base glue layer are in a melted state, so that the non-conductive base glue layer is higher than the metal contact surface or the metal contact surface is trapped into the base glue layer, and a non-conductive foreign substance formed between the pushbutton 7 and the PCB 8 causes a poor conductive function. Therefore, the double-sided metal mesh conductive particle 6 of the invention has the features of high product yield and good electrical conductivity.

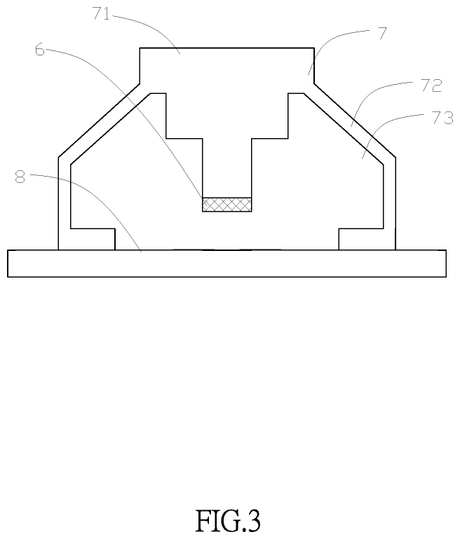

With reference to FIG. 3 for a pushbutton 7 having the double-sided metal mesh conductive particle 6 in accordance with this invention, the pushbutton 7 is one with an electrical contact function. The pushbutton 7 comprises a double-sided metal mesh conductive particle 6, a pushbutton head 71, and a pushbutton elastic wall 72 coupled to a lower end of the pushbutton head 71, and s chamber 73 formed and enclosed by the pushbutton head 71 and the pushbutton elastic wall 72, and the lower end of the pushbutton elastic wall 72 is coupled to the PCB 8, and the double-sided metal mesh conductive particle 6 is coupled to the lower end of the pushbutton head 71 and disposed in the chamber 73. The pushbutton 7 has the features of good electrical conductivity, high reliability, and long service life. When the double-sided metal mesh conductive particle 6 of this invention is installed to the pushbutton 7, the double-sided metal mesh conductive particle 6 is installed to the bottom of the pushbutton head 71 and disposed in the chamber 73 formed and enclosed by the pushbutton elastic wall 72. When the pushbutton head 71 is not pressed, the double-sided metal mesh conductive particle 6 and the PCB 8 are not in contact with each other. When the pushbutton head 71 is pressed, the double-sided metal mesh conductive particle 6 and the PCB 8 are contacted to conduct the circuit. Since the double-sided metal mesh conductive particle 6 has the double-sided conduction function, therefore either surface of the double-sided metal mesh conductive particle 6 can be used as a conductive contact surface, and it is not necessary to identify the surfaces during the installation process, and thus this invention can prevent wrong installation and improve the production efficiency and product yield significantly.

While the invention has been described by means of specific embodiments, numerous modifications and variations could be made thereto by those skilled in the art without departing from the scope and spirit of the invention as set forth in the claims.

What is claimed is:

1. A double-sided metal mesh conductive particle, comprising: a first metal mesh layer, a first adhesive layer, a base layer, a second adhesive layer, and a second metal mesh layer arranged sequentially from top to bottom; and an upper surface of the first metal mesh layer having a plurality of first conductive bumps, and a lower surface of the second metal mesh layer having a plurality of second conductive bumps.

2. The double-sided metal mesh conductive particle as claimed in claim 1, wherein the base layer is a silicone layer.

3. The double-sided metal mesh conductive particle as claimed in claim 1, wherein the plurality of first conductive bumps is uniformly distributed on an upper surface of the first metal mesh layer; and the plurality of second conductive bumps is uniformly distributed on a lower surface of the second metal mesh layer.

4. The double-sided metal mesh conductive particle as claimed in claim 1, wherein the lower surface of the first metal mesh layer and the upper surface of the first adhesive layer are adhered with each other, and the plurality of first conductive bumps is protruded from the first adhesive layer.

5. The double-sided metal mesh conductive particle as claimed in claim 4, wherein the height of the plurality of first conductive bumps protruded from the first adhesive layer is not less than half of the thickness of the first metal mesh layer.

6. The double-sided metal mesh conductive particle as claimed in claim 1, wherein an upper surface of the second metal mesh layer and a lower surface of the second adhesive layer are adhered with each other, and the plurality of second conductive bumps is protruded from the second adhesive layer.

7. The double-sided metal mesh conductive particle as claimed in claim 6, wherein the height of the plurality of second conductive bumps protruded from the second adhesive layer is not less than half of the thickness of the second metal mesh layer.

8. The double-sided metal mesh conductive particle as claimed in claim 1, wherein the first metal mesh layer and the second metal mesh layer are iron mesh layers, copper mesh layers, nickel mesh layers, stainless steel mesh layers, titanium mesh layers, gold mesh layers, sliver mesh layers, gold plated mesh layers, silver plated mesh layers, copper plated mesh layers, nickel plated mesh layers, titanium plated mesh layers or chromium plated mesh layers.

9. The double-sided metal mesh conductive particle as claimed in claim 1, wherein the first adhesive layer and the second adhesive layer are adhesive layers made of the same material.

10. A pushbutton having a double-sided metal mesh conductive particle, comprising the double-sided metal mesh conductive particle as claimed in claim 1
